(19) United States
(12) Patent Application Publication
(10) Pub. No.: US 2007/0294099 A1
(43) Pub. Date: Dec. 20, 2007

(54) Physical On Demand Product Creation System and Method

(75) Inventors: Peter B. Rowland, Hopkins, MN (US); Anton Petersen, Richfield, MN (US)

Correspondence Address: NORTH OAKS PATENT AGENCY, 45 ISLAND ROAD, NORTH OAKS, MN, 55127, US

(73) Assignee: DIGITAL RIVER, INC., Eden Prairie, MN (US)

(21) Appl. No.: 11/694,878

(22) Filed: Mar. 30, 2007

Related U.S. Application Data
(60) Provisional application No. 60/787,828, filed on Mar. 31, 2006.

(51) Int. Cl. G06Q 50/00

(52) U.S. Cl. 705/1

(57) ABSTRACT

Software publishers generally want to produce on demand software CDs or DVDs as required for purchases to avoid maintenance of the stock of product. All of the CDs or DVD contents and graphics have to be uploaded and maintained. Physical on demand allows one to sell physical copies of software created to order. No extra inventory remains and there is no need to dispose of obsolete products. Furthermore, clients generally want to produce on demand software CDs as required for purchases and avoid maintenance of the stock of product. With physical on demand fulfillment process, there will be no concerns surrounding backorder or cancellation of orders.

### RELATED APPLICATIONS

This application claims the benefit of U.S. Provisional Application No. 60/782,825 filed 15 Mar. 2006, entitled “Physical On Demand,” which is incorporated herein by reference.

### FIELD OF THE INVENTION

The present invention relates to the field of multimedia, computers, and multimedia system, and, more particularly, to the set up and initiation of the creation of compact discs containing full product files such as executables, binaries and other formats.

### BACKGROUND OF THE INVENTION

Over the years, computers have developed to bring tremendous changes to technology, company operations, and various aspects of personal and work lives of individuals. With the widespread advent of computers, multimedia has developed to communicate information, entertain, archive information, and provide information to users of computers and other multimedia systems. Relatively recently, compact discs have been developed for storing and retrieving large amounts of information or data when desired to be accessed by users. Magnetic compact discs, i.e., floppy discs, having a rectangular shape were first developed, and custom magnetic disc readers soon became a standard on many computers. Because of the ability to store even larger amounts of digital data, annular-shaped optical compact discs soon became a standard for storing information such as new software programs. The sizes of these annular-shaped compact discs were about 120 mm, and later 80 mm annular-shaped compact discs were developed. Accordingly, computers and other hardware had optical compact discs as standard equipment for loading software and storing and retrieving other data for users. One of the problems with optical compact discs, however, is that these discs are a type of read-only memory (“ROM”) or CD-ROM. In other words, for years it was not possible to write new information to the disc. Accordingly, magnetic compact discs did not and have not yet become obsolete. The cost effective manufacturing and widespread distribution of the CD-ROM, however, continues to make it attractive to users.

Historically, to make physical software, one would have to make many copies of the product which may or may not sell before the product is obsolete. A need exists for a system that allows the user to sell physical copies of software created to order. Furthermore, a need exists for prevention of extra inventory and less disposal of obsolete products.

The present invention provides a solution to these needs and other problems, and offers other advantages over the prior art.

### BRIEF SUMMARY OF THE INVENTION

Software publishers generally want to produce on demand software CDs or DVDs as required for purchases to avoid maintenance of the stock of product. All of the CDs or DVD contents and graphics have to be uploaded and maintained. Physical on demand allows one to sell physical copies of software created to order. No extra inventory remains and there is no need to dispose of obsolete products. Furthermore, clients generally want to produce on demand software CDs as required for purchases and avoid maintenance of the stock of product. With physical on demand fulfillment process, there will be no concerns surrounding backorder or cancellation of orders.

### BRIEF DESCRIPTION OF THE DRAWINGS

FIG. 1 shows a sample user interface site set up to support physical on demand.

FIG. 2 shows a sample user interface page to set up particular product information.

FIG. 3 illustrates a sample user interface page to upload contents of a CD.

FIG. 4 illustrates a page to select an image to be printed on a CD.

FIG. 5 illustrates a confirmation page for selecting an image.

FIG. 6 shows a page for uploading a CD jacket image.

FIG. 7 shows a summary page detailing product setup.

FIG. 8 describes a page for quality assurance to search for new physical on demand versions.

FIG. 9 describes a search results screen for selecting a version for quality assurance.

FIG. 10 illustrates an intermediary page after selecting a version for quality assurance.

FIG. 11 shows a page to burn an optional test CD.

FIG. 12 shows a page that the user may see if a version is rejected.

FIG. 13 shows an overview diagram of system and method for physical on demand product creation.

### DETAILED DESCRIPTION

In a preferred embodiment of physical on demand, an application process was built to allow the upload of the large amounts of data required to build a CD via FTP rather than HTTP. Images are uploaded for both the case and the CD Label. When the media has been uploaded, the product is sent through a quality assurance (“QA”) process including the burning of the disk to validate that the contents are of merchantable quality.

### Product Setup

The product may set up using a product manager. A product can be selected as an on demand fulfillment. This will indicate that the product upon purchase will be fulfilled through the creation of the product CDs at a predefined CD burning facility. This ability to fulfill through on demand will only be available for products which are sold within Europe.

At a site level, CD fulfillment location will be determined and established. For phase I, the fulfillment centers may be either the United Kingdom (UK) or United States (US). Therefore, any and all CD products that are required for European fulfillment will be established in the UK while all others will remain in the US.

For products that are fulfilled through physical on demand, a user will have the ability to maintain the following information:
Case Label information; includes image, spine text and text color, front case text areas and associated colors (areas yet to be defined);
CD Information; includes background image and text color; and
File uploads and associate files required for product. Space required for the files will require validation. The system must ensure that the files take up no more than two CD's worth of space. In the event that this occurs, an error will be displayed to the user.

In addition, physical on demand products will be created as two products; CD and Case. The case product will always be a tightly bundled product with the CD. The case product will not be available for purchase or visible to a customer at any time. This is product is required for satisfying the fulfillment of the physical on demand product set.

### Product Purchase

At time of purchase for any product requiring CD fulfillment, a fulfillment request will be forwarded to the associated CD fulfiller for the site. Physical on demand products will be considered “requesting fulfillment” at time of the fulfillment request. The fulfiller will supply a shipment notice. This notice will act as the indicator of fulfillment triggering any events such as costing, accounting and order notifications.

### Product Fulfillment

Orders placed for physical on demand products will not be available for cancellation or backorder. It will be understood that three servers will manage all physical on demand requests. Two machines will be utilized for fulfillment of physical on demand requests. Physical on demand machines will require the ability to print CD information in color. In the event a physical on demand machine goes down, the second physical on demand machine will maintain processing of the requests. Upon receipt of a Physical on Demand fulfillment request, the machine will extract all files required and burn to a CD. These files include executables, binaries and other formats. Furthermore, case labels generated for physical on demand will contain a return address, mailing address, and barcode. CD labels generated will contain a customer name, barcode, disc number (i.e., “1 of X”), and an order Id.

Moreover, barcodes contained on the case label and the CD label will be scanned and matched to allow the completion of the pick/pack/ship process. Orders which contain two CD's will require the ability to associate each CD barcode with the same label barcode. Additionally, a group of United Parcel Service (“UPS”) tracking numbers will be available to the CD fulfiller. From this pre-assigned tracking number group, a tracking number will be extracted and associated to the physical on demand order. UPS will be notified of package information once the order has been associated. Once the product is shipment ready, the CD fulfiller will create a shipment notice file. This file will contain order information as well as tracking information that confirm orders that have been fulfilled. During the implementation, a time frame for these files will be established.

### Post Fulfillment Processing

The order fulfiller will receive a shipment notice from each CD fulfiller. Upon receipt of the file, the order will be updated with shipment information. The shipment confirmation notification will be forwarded to the customer with the provided tracking information. Costing and accounting for shipped orders will be processed as they are currently by physical orders. Once the order reaches a state of “fulfilled”, costing will be triggered and allow for recognition of revenue.

### Customer Service and Reporting

Once an order is placed, there will be no ability to cancel an order. There is no impact to customer service. Physical on demand will be integrated to process just as current physical fulfillment is integrated with customer service. For reporting, current reporting to customers on orders will not be impacted since physical on demand fulfillment will act as any physical fulfillment. Accounting reports such as the penetration report will operate normally. Fulfillment of physical on demand will be integrated to act as any physical fulfillment of product is currently reported.

### Notifications

Standard order confirmation will be utilized for physical on demand fulfillment. This fulfillment process will act as any physical fulfillment currently does. Customers will be informed that further notification from the order fulfiller will indicate when fulfillment has been completed.

Standard shipping confirmation will be utilized for physical on demand fulfillment. Upon receipt of shipping notification from the fulfiller, an e-commerce system will generate this notification to the customer to indicate fulfillment has been completed and product should be expected shortly.

### Page Mock Ups

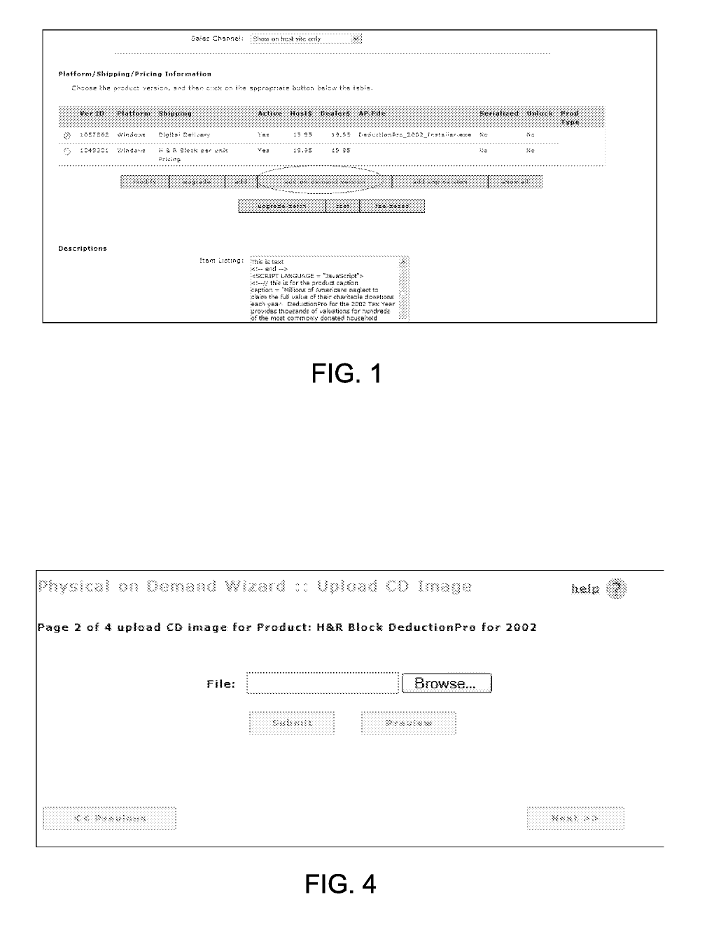

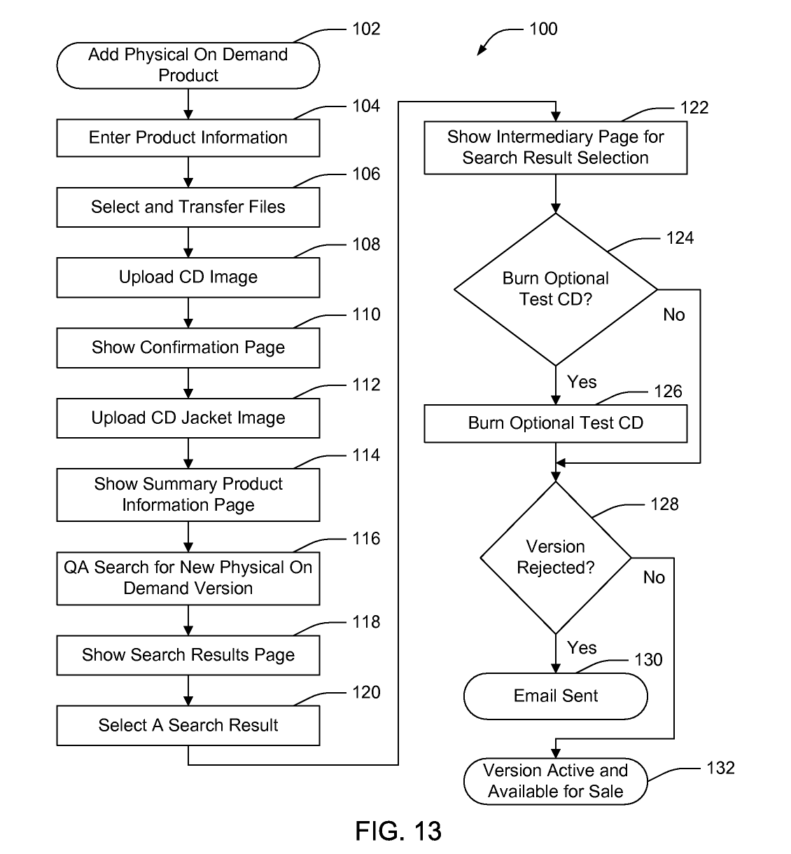

FIG. 13 shows an overview diagram of system and method for physical on demand product creation. The overview flow chart diagram shows the steps illustrated in FIGS. 1-12.

As will be described infra, a product search page allows a client or administrator to select a product from a product manager. A “Product Selection/File Selection Page” allows the client or administrator to select what digital product the physical on demand will correspond to. They will also upload the relevant files and file structure that is to be burned onto the CD. An “Upload CD Image Page” allows the client and administrator to upload an image for the top of the CD itself. They will also be able to view what the CD would look like with the image on it. An “Upload Jacket Page” allows the client and administrator to upload images for the front, back and spine of the CD jacket. The client and administrator will also be able to preview what the jacket will look like. A “Choose Fulfillment Center Page” gives the client and administrator the ability to choose where the physical on demand product will be shipped from. A “Setup Complete Page” informs the client/administrator that the setup process is complete. It will be understood by one of ordinary skill in the art, as shown in Table 1 below, that there are basic print and design specifications that a user may need to note.

TABLE 1
Print and Design Specifications

Label insert measurement - (Bleed Zone) The insert for the DVD case will
measure 7¼ × 10¾ inches. (Live Zone = image size = cut line =
7¼″ × 10¾″)
Resolution - For both the CD label and the DVD case the resolution is
300 dpi.
The DVD case should be in PDF and the CD label in Microsoft JPEG
300 DPI
Image Format - The image for both the CD label and DVD case label
must be a Microsoft JPEG.
Bleed zone = Any edge with a full-bleed should extend ¼″ beyond
the cut line. Consequently since the DVD case label is a 4-edge bleed
image, the size would be 7⅝″ × 11″) text should be no closer
than ¼″ from the edge of the cut line.
Color Range - The printers are CMYK but an “RGB.eps” image is
preferred for the DVD cover only.

### Modify Product

In a preferred embodiment of physical on demand, there is a method to create a new and modify an existing physical on demand product. As shown in FIG. 1, a user interface site is set up to support physical on demand, with an option 102 for an “add on demand version” button. This allows the user to set up a new physical on demand product. The user should click on the “add on demand version” button to go to the next step of setting up a new physical on demand product.

### Product Setup

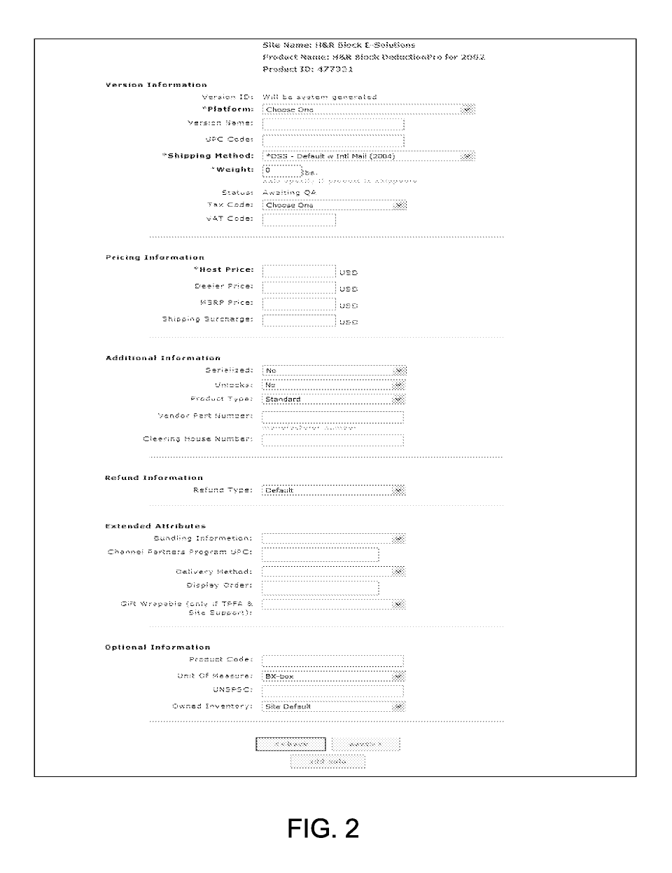

FIG. 2 shows a page to enter 104 particular product information. A user may enter data such as version information, platform, shipping method, pricing information, refund information, extended attributes, and optional information. The user would then click “next” to move onto the next step of physical on demand creation.

### Select and Transfer of Files

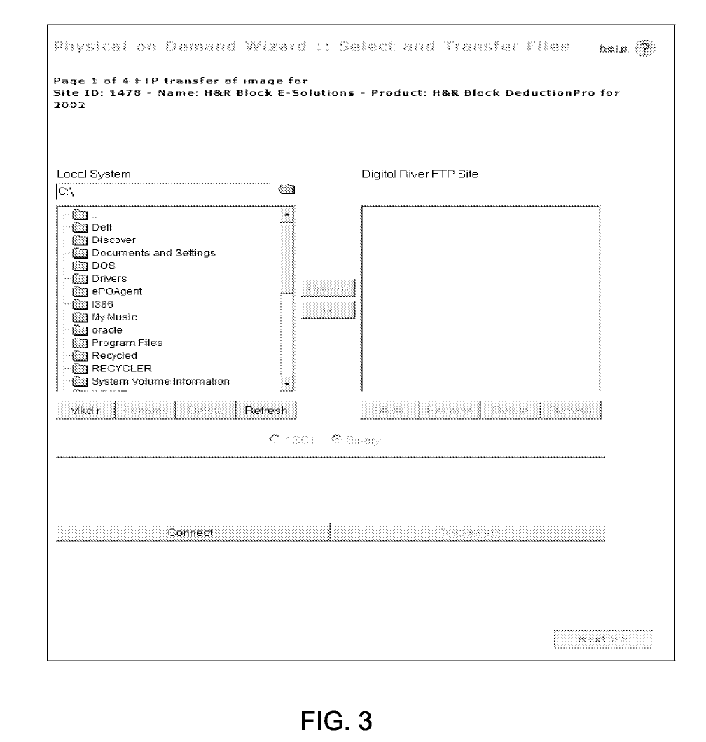

Referring now to FIG. 3, using an FTP Applet embedded in the page; the user is directed to upload the contents of the CD to the FTP Server. The contents can be a directory structure with files, or a self extracting archive. When the user logs in, they will upload 106 the contents to a directory created by the application; their session will be “rooted” to this directory, so they cannot upload the contents to the wrong location. Once the user clicks on “Next”, the server scans the uploaded content for viruses and spyware/adware before moving it to the production physical on demand file system.

### Upload CD Image

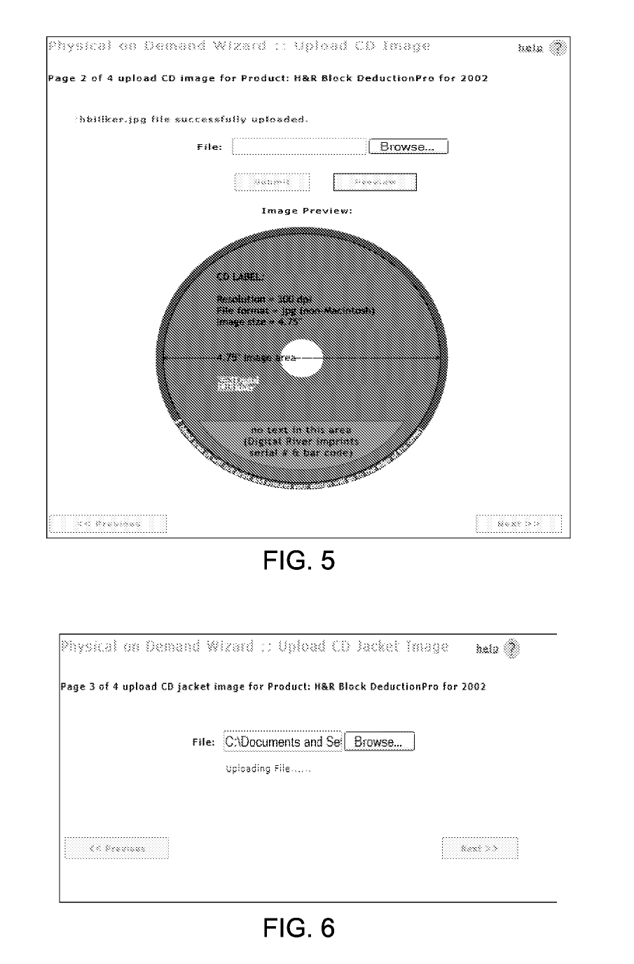

Moving onto FIG. 4, the user selects the image to be printed on the CD from their local hard disk. When the user clicks “Submit,” the file is uploaded 108 to the FTP server via HTTP, where it is scanned for viruses and spyware/adware. It is then moved to a production physical on demand file system. The user then is presented with a confirmation page as shown 110 in FIG. 5.

### Upload CD Jacket Image

As described in FIG. 6, uploading a CD jacket image 112 follows the same process as the CD image. The file is uploaded via HTTP to the server where it is scanned, and then moved to the physical on demand production file system. Once the file has been successfully uploaded, the user is presented with a confirmation page showing the image and the preview of the CD case image.

### Setup Complete

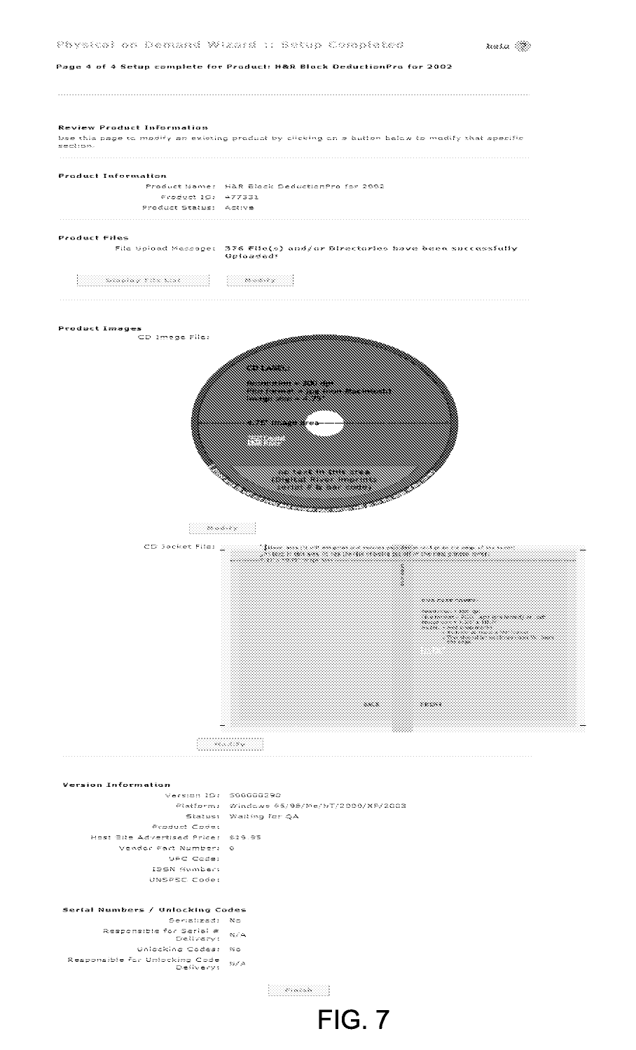

Once product set up in complete, the user is presented 114 with a summary page detailing the information as shown in FIG. 7. The summary page outlines various product information, product file data, product image, version information, and serial number and unlocking codes. This summary page allows the user to review the information entered and uploaded in FIGS. 1-6. The user also has an opportunity to modify the CD image and the product information.

### Product Activation

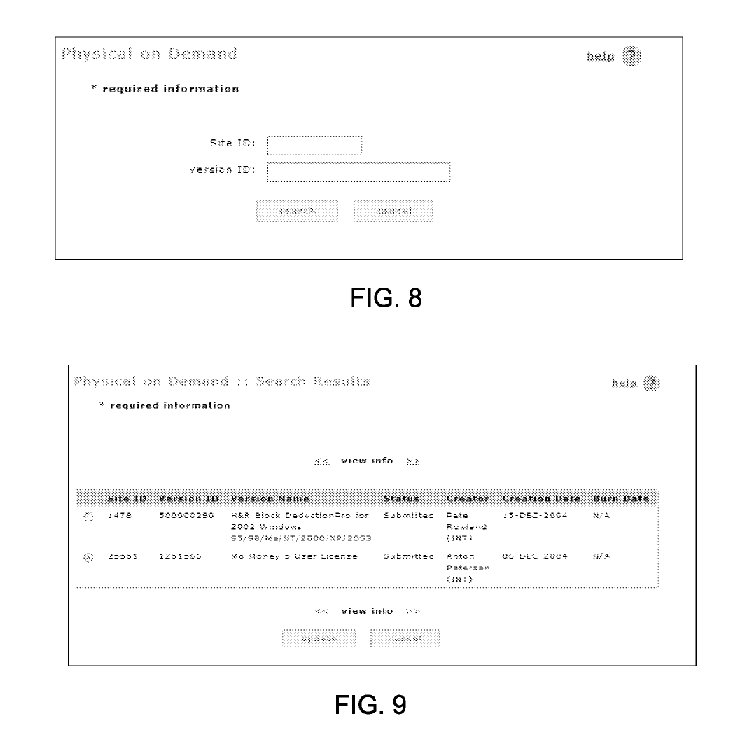

Once a physical on demand version has been setup through the product manager, it is unavailable for sale until it has been through a quality assurance (QA) process. In FIG. 8, the QA Analyst enters the QA application, and is able to search 116 for new physical on demand versions either by site identification to list all new versions for that site, or by specific version. If the user enters no search term, all versions awaiting QA are displayed 118. From the search results screen, shown in FIG. 9, the user has the option to select 120 a version for QA.

### Update Request

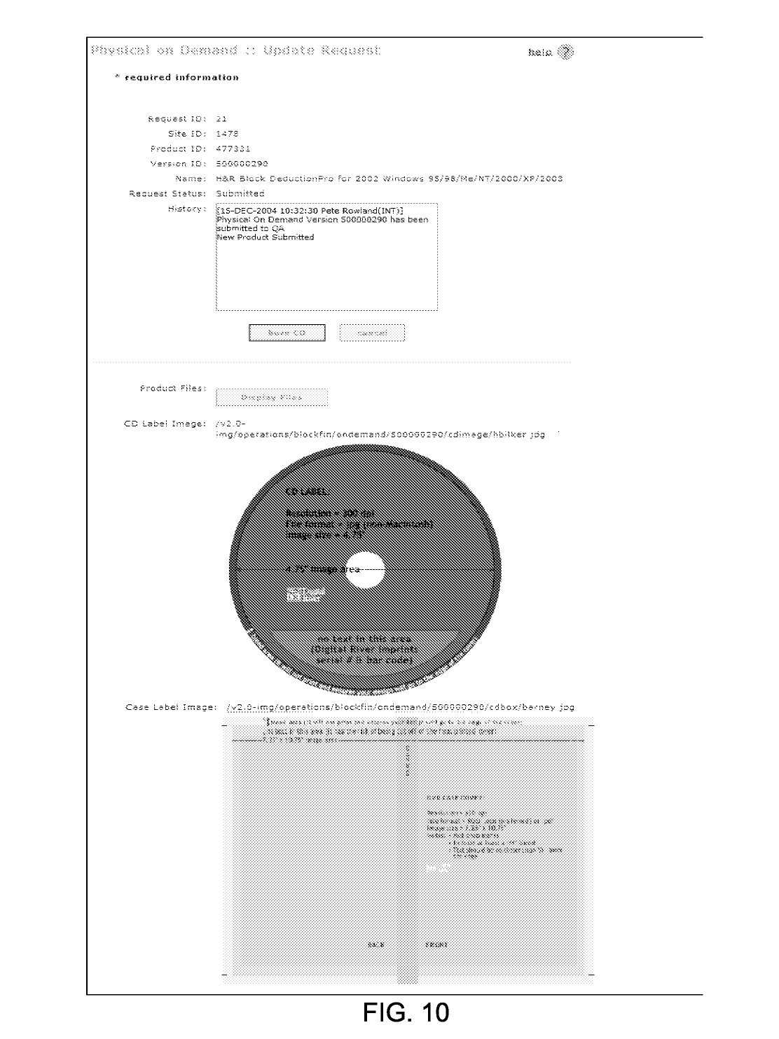

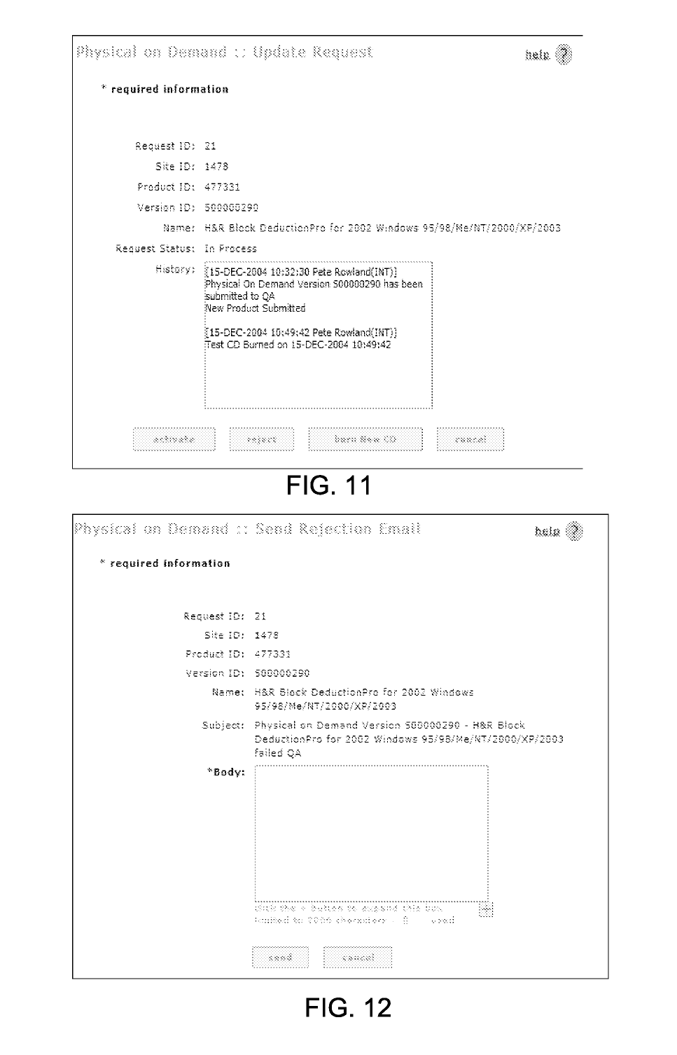

Once the user has selected the version for QA, they go to the screen displayed 122 in FIG. 10. Here the user may review the required information and enter product history. The CD label image is also shown again with further details, such as a case label image. Referring now to FIG. 11, when in this screen, a user has the option 124 to burn a test CD for the product. Once this CD has been burned 126, the analyst has the option 128 to accept or reject the version.

Furthermore, if the version is rejected, as shown in FIG. 12, an email is sent 130 to the person who originally created the product detailing why it has failed QA, and what needs to be done to correct the problem. If the version passes QA, then the version is set 132 as active and available for sale, and the person who created the product is notified by email. Once a version is active, no further changes can be made to it, other than to make the version inactive. Once a version is inactive, it cannot be reactivated.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the web interface such that different dialog boxes are presented to a user that are organized or designed differently while maintaining substantially the same functionality without departing from the scope and spirit of the present invention.

What we claim:

1. A method for creating a physical on demand product for remote manufacturing of software media from a network, comprising steps of:
entering product information for a version of a physical on demand product through a web-based interface over the network to a remote manufacturing system;
transferring files that comprise the version of the physical on demand product to the remote manufacturing system;
uploading CD image for the product version to the remote manufacturing system;
uploading CD jacket image for the product version to the remote manufacturing system; and
making the product version active and available for sale after approval from quality assurance.

2. The method of claim 1 further comprising a step of requesting approval of the created product version from quality assurance.

3. The method of claim 1 further comprising a step of providing test CD burn capability to a user as part of a quality assurance approval process.

4. The method of claim 1 wherein the transferring step comprises utilizing file transfer protocol (FTP) to transfer the files that comprise the version of the physical on demand product to the remote manufacturing system.

5. The method of claim 1 further comprising a step of rejecting the product version by sending an electronic mail to a user that originally created the product version.

6. A system for creating a physical on demand product for remote manufacturing of software media, comprising:
a remote manufacturing system operatively configured to store and create the physical on demand product;
a web-based interface, operatively coupled to the remote manufacturing system, comprising:
a product information module for entering product information for a version of a physical on demand product and sending the entered product information over a network to the remote manufacturing system;
file transfer module for transferring files that comprise the version of the physical on demand product to the remote manufacturing system; and
upload module operatively configured for: (i) uploading CD image for the product version to the remote manufacturing system, and (i) uploading CD jacket image for the product version to the remote manufacturing system; and
an approval module, operatively coupled to the remote manufacturing system, for making the product version active and available for sale after approval from quality assurance.

7. The system of claim 6 wherein the web-based interface is configured to request approval of the created product version from quality assurance.

8. The system of claim 6 wherein the remote manufacturing system is configured to provide test CD burn capability to a user as part of a quality assurance approval process.

9. The system of claim 6 wherein the file transfer module is configured to utilize file transfer protocol (FTP) to transfer the files that comprise the version of the physical on demand product to the remote manufacturing system.

10. The system of claim 6 wherein the approval module is configured to reject the product version by sending an electronic mail to a user that originally created the product version.
